(19) United States
(12) Patent Application Publication
(10) Pub. No.: US 2003/0138372 A1
(43) Pub. Date: Jul. 24, 2003

(54) Method for identifying and synthesizing high dielectric constant perovskites

(75) Inventors: Jonh B. Parise, East Setauket, NY (US); Patrick M. Woodward, Columbus, OH (US); Jae-Hyun Park, Doublin, CA (US)

Correspondence Address: Ronald J. Baron, Esq., HOFFMANN & BARON, LLP, 6900 Jericho Turnpike, Syosset, NY, 11791, US

(73) Assignee: The Research Foundation of State University of New York

(21) Appl. No.: 10/185,432

(22) Filed: Jun. 28, 2002

Related U.S. Application Data
(63) Continuation-in-part of application No. 09/300,869, filed on Apr. 28, 1999, now abandoned.

(51) Int. Cl. C01B 19/00; G06G 7/48; G06G 7/58

(52) U.S. Cl. 423/508; 703/12

(57) ABSTRACT

A method for forming stable structures which includes identifying compositions having a high probability of forming stable structures using predictive modeling and synthesizing the compositions under high pressure and high temperature conditions to form the stable structures. Preferred stable structures are perovskites having a three-dimensional framework of corner-linked MX₆ octahedra. The predictive modeling allows evaluation of structural stabilities of given compositions while providing hypothetical molar volumes. It also estimates the molecular polarizability of the compositions from the atomic polarizabilities of its constituent ions. The predictive modeling also calculates the relative dielectric constant of the stable structures using the Clausius-Mossotti relationship and selects compositions having combinations of ions with complimentary ionic radii and bonding preferences. The synthesis of the identified compositions is carried out using high temperature and high pressure techniques to induce a structural transition of the composition to a denser phase.

This application is a continuation-in-part of U.S. patent application Ser. No. 09/300,869, filed on Apr. 28, 1999.

### BACKGROUND OF THE INVENTION

The present invention relates to the art of dielectric materials and, in particular, to more efficiently identifying and preparing materials having stable structures and superior dielectric properties.

Recent progress in microwave integrated systems for telecommunication and satellite television applications has necessitated the development of a variety of hyperfrequency devices, for use as filters and frequency-stabilized oscillators. The dielectric properties of materials used to construct such devices must meet very stringent requirements. The important material characteristics include a high dielectric constant (κ>20) in order to miniaturize the size of the device, a low loss factor (tan δ<1.0×10⁻⁵) at the operating frequency to minimize band width, and a small temperature coefficient of resonant frequency (τ_{f}<±25 ppm/K), which is crucial for stability.

Table 1 contains dielectric properties for select materials that are currently being used in

Table 1 contains dielectric properties for select materials that are currently being used in microwave dielectric applications. For many applications, the size and performance of operating devices are limited by the dielectric properties of the materials. Consequently, there is great interest in finding new materials with superior dielectric properties, including a high dielectric constant (κ). A review of Table 1 shows that perovskites are one of the most widely used materials in electronic devices.

TABLE 1
DIELECTRIC PROPERTIES OF MICROWAVE CERAMICS

| Material | κ | Loss Factor | Utility |
|---|---|---|---|
| MgTiO₃ composites | 20 | 2.7 × 10⁻⁵ | a |
| Ba₂Ti₉O₂₀ and modifications | 38 | 2.2-3.7 × 10⁻⁵ | f,o,s |
| Ba₂Ti₉O₂₀/BaTi₄O₉ composites | 38 | 2.0 × 10⁻⁵ | f,o,s |
| Ba₂Ti₉O₂₀/BaTi₄O₉ | 34-37 | 2.0 × 10⁻⁵ | f |
| composites (with | | | |
| compounds of Zn and Ta, Nb) | | | |
| (Zr,Sn)(Ti,Sn)O₄ | 36-38 | 2.2 × 10⁻⁵ | f,o,s |
| (La,Ca)(Mg,Ti)O₃ | 50 | 2.5 × 10⁻⁵ | f,r |
| Ba, Ln-titanates and composites | 80-90 | 8-14 × 10⁻⁵ | f,s |
| (where Ln = Sm/Nd) | | | |
| Ba₃Ta₂ZnO₉ | 30 | 1.0 × 10⁻⁵ | o |
| Ba₃Ta₂MgO₉ | 20 | 0.5-0.6 × 10⁻⁵ | o |

where: a = antennas, f = filters, o = oscillators, s = substrates, r = new radar

The dielectric properties of perovskites have been identified as being particularly useful in electronic devices. Perovskite is a natural crystalline mineral composed of calcium dioxide and titanium dioxide, and it is also a structure type which includes more than 150 synthetic compounds. The perovskite crystal structure is ideally cubic, but distortion leads to lower crystal symmetries. The essential features of the crystal structure include a framework of corner-sharing titanium centered oxygen octahedrons in which calcium atoms are embedded, coordinated by 12 nearest oxygen atoms. The perovskite structure type is of great technical interest, since slight distortions away from cubic symmetry result in noncentrosymmetric (polar) arrangements which may have ferroelectric and antiferroelectric properties. Synthetic perovskite structures with such distortions have been found to possess enhanced dielectric properties.

Currently, the search for new materials which have superior dielectric properties has been conducted on a trial and error basis, wherein new composite materials are formed and then tested to determine their actual dielectric properties. Because of the numerous materials that have to be formed and tested before a new material can be identified, these methods are costly and inefficient. As a result, there is a need for a more efficient method for identifying materials with superior dielectric properties.

Thus, the present invention is intended to overcome deficiencies in the development of new materials for use in electronic devices, and especially those shortcomings related to predicting compositions which will form stable structures with superior dielectric properties.

### SUMMARY OF THE INVENTION

The present invention overcomes the problems found in the prior art by providing a method for more efficiently identifying and forming stable structures having superior dielectric properties. The method provides a material having a high dielectric constant and a structure which is stable at high pressures by identifying a composition having a high probability of forming a stable structure using predictive modeling. Once identified, the composition is then synthesized under high pressure and high temperature conditions to form the stable structure, which has a high dielectric constant and is stable in the high pressure phase. In one embodiment, the stable structure can have a three-dimensional framework of corner-linked MX₆ octahedra. In another embodiment, the stable structure can be an A-cationed ordered crystalline structure. In a preferred embodiment, the stable structure is a perovskite, which can be formed from a composition containing ilmenite.

The stable structures with superior dielectric properties are identified by computer based predictive modeling which analyzes compositions to determine if they will form such structures, and also analyzes the theoretical structures that will be formed to determine their dielectric properties. The predictive modeling can include estimating the molecular polarizability of a composition from the atomic polarizabilities of its constituent ions, determining its molar volume and calculating its relative dielectric constant using the Clausius-Mossotti relationship; and selecting compositions having combinations of ions with complimentary ionic radii and bonding preferences. The predictive modeling can also include determining the size of the octahedra of the structure based on the metal-oxygen bond distance and calculating the dielectric characteristics of the stable structure based on the size of the octahedra, the octahedra tilt system and the magnitude of the tilt angles. The predictive modeling method has at least a 50 percent probability of forming a stable structure from the composition that is identified and, in a preferred embodiment, at least two out of three compositions identified by the predictive modeling form stable structures.

Once a composition has been identified by predictive modeling as having a high probability of forming a stable structure with superior dielectric properties, the composition is synthesized under high pressure and high temperature conditions. The synthesis can include distorting structure by octahedral tilting, cation displacements, Jahn-Teller distortions of the octahedra or cation ordering. The synthesis can also include inducing a structural transition of the composition to a denser phase and is carried out at temperatures of at least about 700° C., preferably at least about 1000° C., and pressures of at least about 5.0 GPa, preferably at least about 7.0 GPa. The material formed by the synthesis has a high dielectric constant and is stable in the high pressure phase and, when the synthesized structure is returned to about one atmosphere pressure, it remains stable. Preferred compositions are those which have superior dielectric properties when formed into perovskite structure by transformation from lower pressure polymorphs such as ilmenites. A preferred perovskite structure is an A-site ordered perovskite.

The compositions used to form the stable structures of the present invention are metal oxide compounds. Preferred compositions contain oxygen ions, lower valent cations and higher valent cations. For these compositions, the synthesis can include shifting the oxygen ions closer to the higher valent cation. The synthesis can also include a phase transition.

The present invention solves the prior art's problems of costly and time consuming trial and error testing to identify materials with superior dielectric properties. In the prior art methods, new structures are identified on an “educated best guess” basis and then synthesized and tested to determine their dielectric properties. The present invention provides a computer program for evaluating the stabilities of compositions before experiments are performed and, thereby, allows compositions to be identified which are unlikely to be stabilized as perovskites. Using the computer based predictive modeling methods of the invention, theoretical compositions which have a high probability of forming stable structures with superior dielectric properties can be more easily identified. Once identified, these structures can then be formed using high pressure and high temperature synthesizing techniques. Thus, the present invention overcomes the problems found in prior art methods by providing an efficient method for identifying and forming stable structures with superior dielectric properties.

### BRIEF DESCRIPTION OF THE DRAWINGS

Other objects and many attendant features of this invention will be readily appreciated as the invention becomes better understood by reference to the following detailed description when considered in connection with the accompanying drawings wherein:

FIG. 1 shows the results of the Rietveld refinement of the structure of Na₂TiTeO₆ at room temperature.

FIG. 2 shows the results of the Rietveld refinement of the structure of Na₂SnTeO₆ at room temperature.

FIG. 3 shows the results of the Rietveld refinement of the structure of Ca₂NdAgTi₄O₁₂ at room temperature.

FIG. 4 shows the TiO₆ octahedral linkages of the Ca₂NdAgTi₄O₁₂ structure.

FIG. 5 shows the projection of the Ca₂NdAgTi₄O₁₂ structure on the xz plane.

FIG. 6 shows the results of the Rietveld refinement of the structure of NdAgTi₂O₆ at room temperature.

FIG. 7 shows the projection of the structure of NdAgTi2O₆ on the xy plane.

FIG. 8 shows the TiO₆ octahedral linkages of the NdAgTi₂O₆ structure.

### DETAILED DESCRIPTION OF THE INVENTION

The present invention is a method for more efficiently providing dielectric materials. The invention includes predicting the dielectric characteristics and stability of compositions and then synthesizing materials to form these compositions. More specifically, the method predicts how much enhanced the dielectric characteristics of the compositions will be after they are synthesized, and which of the compositions with enhanced dielectric characteristics are likely to be stable. The preferred compositions are those which are stable in the high pressure phase and which have high dielectric constants.

Although various compositions can be identified and synthesized using the method of the invention, perovskite structures are preferred. The perovskite structure type is one of the most frequently encountered structures in all of solid-state inorganic chemistry. The ideal perovskite structure has an AMX₃ stoichiometry and is composed of a three-dimensional framework of corner-linked MX₆ octahedra. The structure is completed by filling the large cavities in the MX₃ network with A cations, which are surrounded by 12 equidistant anions. Although there are many compounds that adopt the ideal cubic structure, distortions from the ideal structure are commonplace. Distortion mechanisms include octahedral tilting, cation displacements, Jahn-Teller distortions of the octahedra and, in AA_MM_X₆ perovskites, cation ordering.

Modern telecommunications require materials with high dielectric constants (κ). One approach to the discovery of new materials is the targeting of compositions with high atomic polarizabilities (α). The main limitation to this approach is the finite number of suitable elements that are available. It has been found that decreasing the molar volume of compositions with high atomic polarizabilities (α) dramatically increases the dielectric constant (κ). Experiments with the quenched high-pressure perovskite polymorph of Na₂MTeO₆ (M=Ti, Sn) show a two-fold increase in the dielectric constant (κ) over the ilmenite form. This result suggests the highest values of dielectric constants (κ) occur for compositions with high atomic polarizabilities (α), which form quenchable compounds at high pressures and temperatures.

The present invention uses a predictive modeling computer program called, “Program Originated To Analyze Tilted Octahedra” (“POTATO”), which models octahedral tilting distortions in different compositions, such as perovskites. Predictive modeling using the POTATO program is discussed in an article by J. -H. Park, P. M. Woodward and J. B. Parise titled, “Predictive Modeling and High-Pressure-High-Temperature Synthesis of Perovskites Containing Monovalent Silver,” Chemistry of Materials, Vol. 10, No. 10, 3092-3100 (1998). The POTATO program generates idealized structures based on the size of the octahedra (which can be accurately estimated from ionic radii or bond valence concepts), the octahedra tilt system, and the magnitude of the tilt angles. The POTATO program can also be used to predict the stability of hypothetical compositions. In this role, POTATO selects combinations of ions that have ionic radii and bonding preferences complimentary to each other, thereby increasing the probability that synthesis of the compositions will lead to new materials.

The framework of the perovskite structure is a three-dimensional network of corner-sharing octahedra. Both simple AMO₃ and double, A₂MMO₆, perovskite compounds are commonly distorted from the ideal cubic structure by tilting of the octahedra. Often, there is very little distortion of the octahedral unit. In these cases, the structure can be almost completely described by specification of the magnitude of the tilts and the sense in which the octahedra tilt with respect to each other.

For simple tilting distortions, there are 23 possible tilting combinations that can occur. This was first recognized and described by Glazer, who developed a notation for describing each of the 23 tilt systems (Glazer, A. M., Acta Crystallogr. 1972 B28, 3384). Hence, the possible tilt configurations are now referred to as “Glazer tilt systems.” From a practical point of view, one very useful aspect of Glazer's work was the prediction of the space group that describes the symmetry of each of the 23 tilt systems. This work was later revisited and extended to ordered double perovskites, A₂MMO₆ (Woodward, P. M., Acta Crystallogr., 1997 B53, 44). Although the space-group predictions of the above papers are useful, it is often very desirable to know the exact lattice constants and atomic positions. This is particularly useful for comparing actual structures with the idealized structures and for generating starting models to use in Rietveld refinements.

Given the Glazer tilt system, tilt angles, M—O bond distance (M—O and M′—O bond distances for ordered perovskites), and the identity of the ions as input. POTATO generates a complete crystallographic description of the unit cell as output. Two output files are created. One file contains a description of the unit cell in space group P1 (Z=8) and the second file contains a unit-cell description where the underlying symmetry of the structure has been properly taken into account. Both files are in “xtl” format.

The POTATO program includes two programs. The first program is “Potato Tilt Program” which calculates the atomic positions of metal and oxygen atoms in a corner sharing octahedral network after undergoing a series of tilting operations about the x, y, and z axes. The second program is “Potato Subroutine Tilt” which is a subroutine that tilts any vector AXMAX degrees perpendicular to the x axis, AYMAX degrees perpendicular to the y axis, and AZMAX degrees perpendicular to the z axis in increments of 0.01 tilts. Both of these programs were written by Patrick M. Woodward in March 1995 and both were updated and revised by Mr. Woodward in October 1996.

The two POTATO programs are being submitted herewith on duplicate compact discs labeled “Copy 1” and “Copy 2.” Each of the two compact discs contains two files. The first file is titled “POTATO TILT PROGRAM” and it was created on Jun. 10, 2002 and is 268,800 bytes in size. The second file is titled “POTATO SUBROUTINE TILT” and it was created on Jun. 10, 2002 and is 273,408 bytes in size. Printouts of these two programs are also being submitted herewith. The two POTATO programs contained on the compact disc and in the printouts are incorporated herein by reference in their entirety.

To run POTATO, first, the individual octahedra are tilted independently, according to the tilt system, and tilt angles entered as input. Then, they are linked together at the corners to form a three-dimensional network. Finally, the program calculates the unit cell constants and converts from Cartesian to fractional coordinates. The coordination of the A cation is not optimized, but rather the A cation is simply placed in the center of its eight nearest neighbor M ions (M and M′ for ordered perovskites). Note that, because the separate tilt operations about each of the three Cartesian axes do not belong to an Abelian group, the final crystallographic description will depend upon the order in which the tilt operations are carried out (Glazer, 1972). This compilation has been circumvented by tilting in 0.01° increments about each of the Cartesian axes in the order x, y, z, x, y, z, x . . . until the final tilting angles are achieved.

POTATO is written in standard Fortran 77 and has been complied for both PC a UNIX systems. The PC version was compiled using a Microsoft Fortran compiler. The PC complied program runs on X86 IBM PC computer and clones with a mathematical coprocessor. The UNIX-complied program has been implemented on a Silicon Graphics Indigo workstation, but should also work on other UNIX-based machines. The program contains 5379 lines of Fortran 77 code, including comment lines. The executable file occupies 118 Kbytes of memory and the source code 145 Kbytes of memory. Typical running times on a 486/66 MHz PC are 1-10 seconds.

Through the predictive modeling approach of the present invention, target compositions can be rapidly evaluated for their affinity to the crystalline structure and their dielectric behavior can be estimated. This results in significantly higher success rates when attempts are made to synthesize the target compositions. In the case of perovskites, the target compositions are evaluated to determine if they will form stable perovskite structures, and to determine the dielectric characteristics of the formed perovskite structure. The present invention uses high pressure-high temperature (HPHT) techniques to introduce otherwise inaccessible phase transitions into target compositions, which allows the relationship between molar volume and dielectric constant (κ) to be directly investigated. Using the HPHT techniques, a diverse array of new materials can be synthesized which previously could not have been made using conventional solid state reaction routes.

High pressure-high temperature synthetic routes are an effective way of synthesizing novel metal oxide compounds. Furthermore, the high packing density of the perovskite structure makes HPHT methods particularly well suited to synthesis of new perovskites. Such phases can then often be retained at ambient conditions by quenching the temperature and slowly releasing pressure. Many existing members of the perovskite family have technologically important dielectric properties. The present invention is intended to identify and synthesize new perovskite structures that have improved dielectric properties.

The molecular polarizability (a) of a material can be estimated from the atomic polarizabilities of the constituent ions. These values have been tabulated and are available in the known literature. Using the molecular polarizability (α) and the molar volume (Vₘ), the relative dielectric constant (κ) can be calculated using the Clausius-Mossotti (CM) relationship. The CM equation provides a direct relationship between the dielectric constant (κ), the molecular dielectric polarizability (α_{D}), and the molar volume (Vₘ) of a material:

$$κ = \frac{{V}_{m} + ( 8 {πα}_{D} ) / 3}{{V}_{m} - ( 4 {πα}_{D} ) / 3} \qquad ( 1 )$$

The molecular dielectric polarizability (α_{D}) can be accurately calculated (to within 5% of the experimental value for “normal” dielectric materials) by summing the polarizabilities of the constituent ions (the “oxide additivity rule”). R. D. Shannon (J. Appl. Phys., 73, 348 (1993)), empirically determined a set of ionic polarizabilities for many elements in the periodic table. Shannon's article is incorporated by reference herein in its entirety. A combination of the Clausius-Mossotti equation, the oxide additivity rule and the ionic polarizabilities is used to predict the dielectric constant of hypothetical materials after the molar volume is estimated. Based on of the relationships in the Clausius-Mossotti equation, most attempts to prepare new high dielectric constant materials have focussed on increasing the molecular dielectric polarizability (α_{D}) by searching for new materials containing highly polarizable cations (i.e., Ba²⁺, Ta⁵⁺, Nb⁵⁺). However, this approach is ultimately limited by the polarizabilities of the elements and, consequently, the number of possible combinations is limited.

The present invention is based in part on the discovery that materials with high molecular polarizabilities (α) can be optimized by exploiting an attainable structural transition to a denser phase. Inspection of the Clausius-Mossotti equation suggests that an increase in molecular polarizability (α), beyond those provided by combining elements with high polarizabilities, can be obtained by decreasing the molar volume (Vₘ). More specifically, this relation implies that the denser phase in an isochemical series will always have the higher value of a. This provides a new pathway for the exploration of materials with high dielectric constants, the use of high pressure synthesis techniques to stabilize dense polymorphs. Since combinatorial synthesis is unlikely to be easily applicable to high pressure experiments above 1 GPa, the method of the present invention uses predictive modeling in order to increase the success rate. Tables for ionic polarizabilities provide a means for identifying compositions which are likely to have high dielectric constants. Structural modeling or empiricism can then be used to predict which of the compositions have high pressure polymorphs that will be retained upon return to room pressure conditions.

### EXAMPLE 1

As an example of the method two compounds, Na₂MTeO₆ (M=Ti, Sn) (i.e., Na₂TiTeO₆ and Na₂SnTeO₆), which adopt ilmenite related structures were tested. (Crystallographic data of Na₂TiTeO₆ and Na₂SnTeO₆ are shown in Table 2.) It is well known that application of pressure can induce transformation from ilmenite to the more densely packed perovskite. It is also known that the ilmenite and perovskite structures are prevalent among high dielectric constant materials (see Table 1). These two factors led to the initial choice of the two test compounds, Na₂TiTeO₆ and Na₂SnTeO₆ ilmenites, since both transform to distorted perovskites at 7 GPa/950° C. In addition, it is of critical importance from an applications point of view that the perovskite structure is retained for both compounds upon quenching to ambient pressure.

TABLE 2
CRYSTALLOGRAPHIC DATA FOR Na₂MTeO₆ (M = Ti, Sn)

| PARAMETER | Na₂TiTeO₆^{a} | Na₂SnTeO₆^{b} |
|---|---|---|
| Wavelength (Å) | 0.800139 | 0.800139 |
| 2θ range (°) | 3-76.5 | 5-66.5 |
| # of variables | 21 | 20 |
| # of reflections | 889 | 694 |
| R_{wp} | 0.0831 | 0.0525 |
| Rₚ | 0.0514 | 0.0389 |
| R(F²) | 0.0895 | 0.0532 |
| Reduced χ² | 36.10 | 15.85 |

where:
The rigid body constraint was imposed on TeO₆ octahedra, whose:
^{a} tilting angle from the coordinate axes and distance are refined.
^{b} tilting angle from the coordinate axes is refined and 0.034 mole % of SnO₂ was included in the refinement.

Dielectric measurements carried out on both ilmenite and perovskite phases of Na₂TiTeO₆ and Na₂SnTeO₆ clearly indicate dramatic increases of dielectric constants (κ) in the perovskite phase (see Table 3). The dielectric constant (κ) and dielectric loss (tan δ) values of Na₂TiTeO₆ and Na₂SnTeO₆ were obtained at 1 MHZ via plane capacitor dielectric contact measurements on dense polycrystalline cylindrical specimens. Sintered disks were readily obtained for the perovskite polymorphs due to the high pressure treatment, while for the ilmenite polymorphs densification was achieved by treating the samples in a piston-cylinder apparatus at 1 GPa/650° C. for 90 minutes. Electrical contact was achieved by sputtering Au—Pd (90%-10%) films onto the circular faces of the disks. The measurements were carried out with a Hewlett Packard Impedance Analyzer (model 4192A). The experimental values of dielectric constant (κ) and molar volume (Vₘ) were then used in conjunction with the Clausius-Mossotti equation to calculate α_{D} for each composition in both ilmenite and perovskite forms. It was found that, upon transforming to the denser perovskite structure, molecular dielectric polarizability (α_{D}) decreases by 7.62% for Na₂TiTeO₆ and 9.94% for Na₂SnTeO₆. This result contradicts the assumptions made in using a structure independent set of ionic polarizabilities to estimate molecular dielectric polarizability. However, the difference in the observed molecular dielectric polarizability values from the calculated values is not totally unexpected, since the more tightly packed perovskite structure has electron clouds about each ion which are less polarizable. Fortunately, the decrease in molar volume (Vₘ) of 12.1% for Na₂TiTeO₆ and 13.9% for Na₂SnTeO₆ is sufficient to overcome the decrease in molecular dielectric polarizability (α_{D}). Consequently, the structural transformation, from ilmenite to perovskite, results in a dramatic increase in dielectric constant (κ) (31.13 to 66.62 for Na₂TiTeO₆ and 25.58 to 42.37 for Na₂SnTeO₆).

TABLE 3
CALCULATED AND OBSERVED DIELECTRIC CONSTANTS AT
ROOM TEMPERATURE OF Na₂MTeO₆ (M = Ti, Sn)

| | | | |
|---|---|---|---|
| Na₂TiTeO₆ | Na₂TiTeO₆ | Na₂SnTeO₆ | Na₂SnTeO₆ |
| ILMENITE | PEROVSKITE | ILMENITE | PEROVSKITE |

Calculated Variables

| | | | | |
|---|---|---|---|---|
| α_{D}^{a} | 11.53 | 11.53 | 11.48 | 11.48 |
| Volume/Z (Å³) | 62.18^{b} | 55.17^{c} | 65.94^{b} | 57.04^{c} |
| κ | 11.44 | 22.08 | 9.08 | 17.11 |

Observed Variables

| Volume/Z^{d} (Å³) | 62.18 | 54.66 | 65.94 | 56.80 |
|---|---|---|---|---|
| κ | 31.13 | 66.62 | 25.58 | 42.37 |
| tan δ | 5.15 × 10⁻⁵ | 7.60 × 10⁻⁷ | 6.58 × 10⁻⁸ | 3.89 × 10⁻⁵ |
| α_{D} | 13.50 | 12.48 | 14.03 | 12.64 |
| where: | | | | |
| ^{a}based on oxide additivity rule, α_{D} (Na₂MTeO₆) per a unit formula ABO₃ = α (Na⁺; 1.80) + | | | | |
| # 0.5 × α(M⁴⁺; M = Ti 2.93 and Sn 2.83) + 1.5 × α(O²⁻; 2.01) + 0.5 × α_{D}(TeO₃; 10.50), | | | | |
| # calculated α_{D}(Na₂TiTeO₆) = 11.53 Å³ and α_{D}(Na₂SnTeO₆) = 11.48 Å³ | | | | |
| # where α_{D} (TeO₃) = α_{D}(Li₂ZrTeO₆; 21.94)¹⁵ − α_{D}(Li₂O; 4.11) − α_{D} | | | | |
| # (ZrO₂; 7.33) = 10.50 compared to α(TeO₂) = 9.30; | | | | |

^{b}the observed volume of the ilmenite phase per a unit formula ABO₃ was used to calculate the dielectric constant;
^{c}the volume of the perovskite was estimated by a* = [(r_{Na} + r_{O}) / (2 + (r_{B} + r_{O})] where r_{B} is the average value of either r_{Ti} or r_{Sn} and r_{Te}, r_{O} = 1.26 Å and r_{Na} = 1.32 Å;
^{d}the observed volume per a unit formula ABO₃.

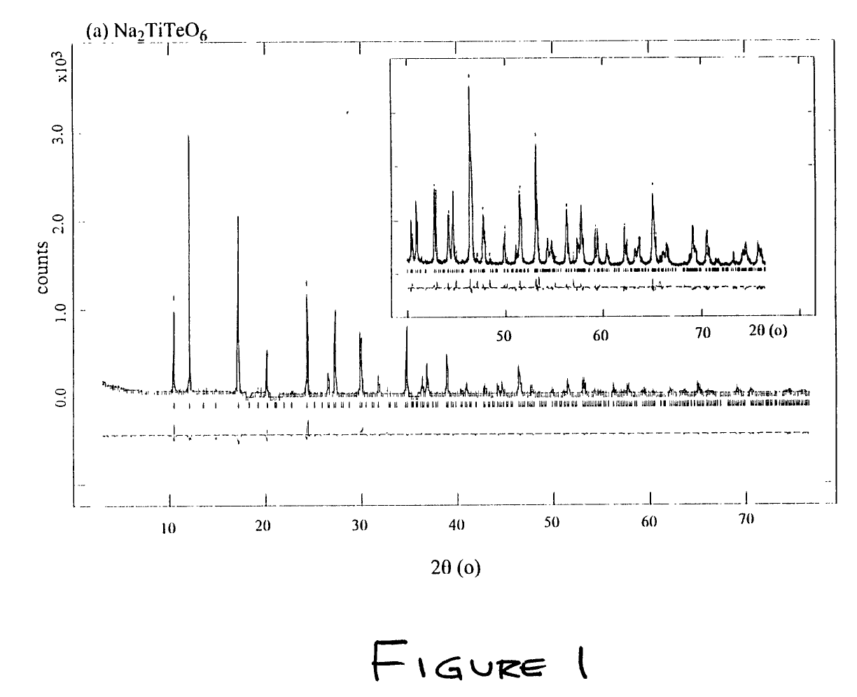

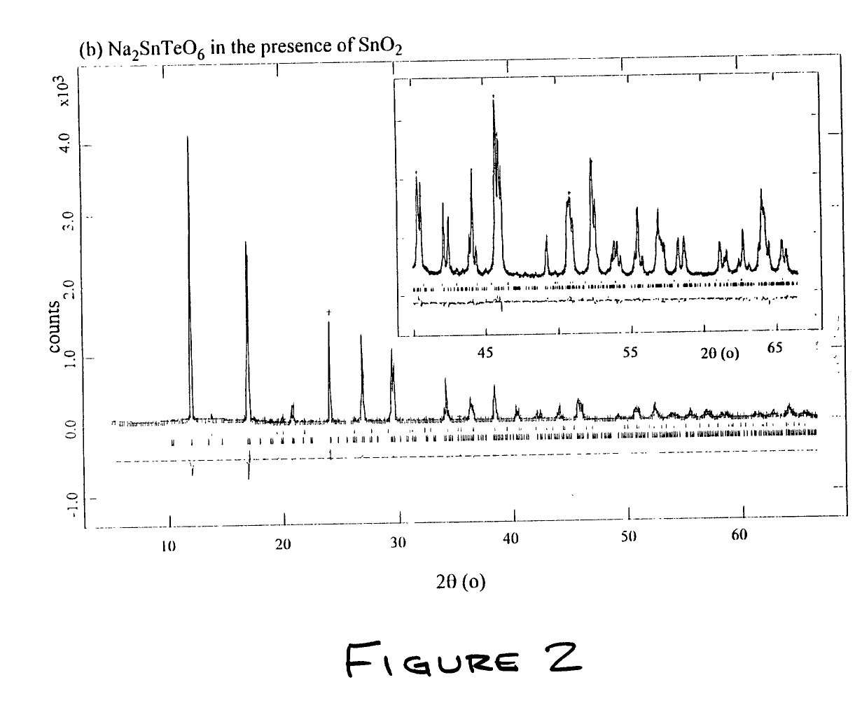

All the samples were structurally characterized using synchrotron x-ray powder diffraction data collected on an X7A beamline at the National Synchrotron Light Source (NSLS) located at Brookhaven National Laboratory (BNL). A summary of these results is given in Table 4. The results of the Rietveld refinements using the data sets of the perovskite compounds are shown in FIG. 1, wherein the observed (cross) and calculated (solid line) synchrotron X-ray powder diffraction profiles and difference curves (I_{obs}−I_{calc}) of high pressure perovskite polymorphs of Na₂TiTeO₆ at room temperature are graphically presented. Allowed reflection positions from Na₂TiTeO₆ are indicated by vertical lines. Similarly, FIG. 2 shows the results of the Rietveld refinements for high pressure perovskite polymorphs of Na₂SnTeO₆ at room temperature. Allowed reflection positions from Na₂SnTeO₆ are indicated by vertical lines and the upper tick marks represent the reflection positions of SnO₂ (0.034 mole %).

The structural analysis of the Na₂TiTeO₆ and Na₂SnTeO₆ structures led to an accurate determination of the space group, unit cell dimensions and metal ion positions. However, the presence in each case of a minor (<3 wt %) unidentified impurity phase(s), whose peaks overlapped in some instances with the perovskite reflections, did not allow for accurate determination of the oxygen positions.

TABLE 4
SYNTHETIC CONDITION AND CRYSTALLOGRAPHIC INFORMATION
OF Na₂MTeO₆ (M = Ti, Sn)

| | Na₂TiTeO₆ | Na₂TiTeO₆ | Na₂SnTeO₆ | Na₂SnTeO₆ |
|---|---|---|---|---|
| | ILMENITE | PEROVSKITE | ILMENITE | PEROVSKITE- |
| Synthetic | 750° C. | 7 GPa/950° C. | 700° C. | 7 GPa/950° C. |
| Condition | | | | |
| Space Group | R3 | P2₁/n | P31c | P2₁/n |
| Cell | a = 5.21781(2) | a = 5.37906(9) | a = 5.3358(1) | a = 5.40361(5) |
| Parameter (Å) | c = 15.8219(1) | b = 5.34743(7) | c = 10.6960(3) | b = 5.46152(5) |
| | | c = 7.59665(8) | | c = 7.69288(7) |
| | | β = 89.960(2) ° | | β = 90.034(3) ° |

Despite the difficulties in precisely locating the oxygen ions, the x-ray diffraction analysis revealed several key structural features. First of all, both compounds undergo a distortion characterized by tilting of Ti(Sn)O₆/TeO₆ octahedra. This distortion is a result of the sodium ion being too small for a cubic MTeO₆²⁻ network. It is the same type of distortion observed in CaTiO₃ and GdFeO₃ (Glazer tilt system a⁻a⁻b⁺). Secondly, the presence of a (111) reflection in each case reveals that both compounds contain an ordered distribution of Ti/Sn and Te. Refinements show that the width and the intensity of this reflection are consistent with complete cation ordering. By comparison, the ilmenite-related polymorphs of Na₂TiTeO₆ and Na₂SnTeO₆ have disordered and ordered cation distributions respectively. The combination of a⁻a⁻b⁺ octahedral tilting and M/Te cation ordering leads to a metrically orthorhombic unit cell, with monoclinic P2₁/n symmetry, as observed for both compounds.

The two-fold increase in the value of dielectric constant (κ) is in line with a prediction based on the Clausius-Mossotti equation; however, the observed dielectric constant (κ) values are three times larger than those obtained by calculation (see Table 3). Some of this behavior can be attributed to metastability of the recovered materials in the decompressed state. However, since the structural studies do not indicate the presence of rattling ions or ferroelectric behavior, the increase in the dielectric constant is the result of the structure-dependence of the atomic polarizabilities. A structure-dependent set of molecular polarizabilities can be calculated based on the dielectric constant versus molar volume (κ vs Vₘ).

### Cation Ordering

It is well known that double substitution on the octahedral site leads to cation ordering when the ionic attributes (ionic radius, formal charge, covalent bonding interactions) of the M and M cations are sufficiently different. For a 1:1 ratio of M and M′, the most stable ordering configuration is invariably a rock salt arrangement. A rare exception to this rule is La₂CuSnO₆, where the Cu²⁺ and Sn⁴⁺ cations order in layers. This unusual ordered arrangement of octahedral cations appears to be stabilized by the Jahn-Teller distortions about Cu²⁺ and a very delicate balance of ionic interactions.

In contrast to ordering of M/M′ cations, there are relatively few examples of A-cation ordering. Examples of A-cation ordering can generally be divided into two categories: those driven by charge and/or size differences between A and A′ cations and those driven by differences in the coordination preferences of A and A′. Examples of the former type of ordering include La_{0.33}□_{0.67}NbO₃, La_{0.67}□_{0.33}NbO₃, La_{0.67-x}Li₃ₓ□_{0.33-2-x}—TiO₃, Na_{0.5+x}La_{0.5-3x}Th₂ₓTiO₃, Na_{0.67}Th_{0.33}TiO₃,La_{1.33}□_{0.67}MgWO₆, NaLaMgWO₆, and Pb_{0.5}Ca_{0.5}TiO₃. With the exception of Pb_{0.5}Ca_{0.5}TiO₃, all of the aforementioned compounds show layered A-cation ordering, rather than the rock salt arrangement associated with M/M′ ordering. It should also be noted that La_{1.33}□_{0.67}MgWO₆ and NaLaMgWO₆ contain rock salt ordering of the M/M′ cations in addition to layered A-cation ordering. However, NaLaTi₂O₆, although it has the same A cations as NaLaMgWO₆, does not show long range ordering of Na⁺ and La³⁺.

Examples of the second type of A-cation ordering, those arising from differences in the coordination preferences of A and A′, belong almost exclusively to a family of compounds with stoichiometry A′A₃M₄O₁₂(A=Cu²⁺, Mn²⁺; A′=Na, Ca, Y, Nd, La, Th; M=Mn, Ti, Ge, Ru). Members of this family include NaCu₃Mn₄O₁₂, CaCu₃Ti₄O₁₂, CaCu₃Ge₄O₁₂, NdCu₃Ru₄O₁₂, and the parent compound of this structure type, NaMn₃Mn₄O₁₂. All of these compounds are perovskites distorted from the ideal structure by an octahedral tilting arrangement described by the Glazer tilt system a⁺a⁺a⁺. The distortion of the oxygen network in this tilt system is such that 25% of the A-site cations have a distorted cubooctahedral coordination with 12 equidistant oxygen neighbors, whereas the remaining 75% have square-planar coordination, as shown in Table 5. Thus, it becomes apparent why this tilt system is adopted by ACu2+₃M₄O₁₂ compounds. The smaller, Jahn-Teller Cu²⁺ cations can fully occupy the square-planar sites, whereas the larger A-cations can occupy the cubooctahedral sites. The a⁺a⁺a⁺ tilt system is not the only tilt system where octahedral tilting and A-cation coordination preferences can act in concert to stabilize coordination-driven A-cation ordering. Octahedral tilting distortions in the tilt systems a⁺a⁺c⁻, a⁰b⁺b⁺, and a⁰b⁺b⁻ also lead to a distribution of A-cation sites with contrasting coordination spheres (see Table 5). However, excluding members of the a⁺a⁺a⁺ tilt system, only one example of coordination driven A-site cation ordering is known, CaFeTi₂O₆ (a⁺a⁺c⁻).

To maximize the driving force for A-cation ordering, the differences in charge, size and/or coordination preferences between the various cations on the A-site must be maximized. From this perspective, the Ag⁺ ion is an attractive candidate to be used in combination with other ions. The ionic radius of Ag⁺(1.28 Å) is considerably larger than the radii of the trivalent cations in the lanthanide series (0.977-1.16 Å), so that A-site-cation ordering might be expected in AgLn³⁺M⁴⁺₂O₆ compositions. Furthermore, unlike the alkali, alkaline-earth, and lanthanide cations, Ag⁺ occasionally adopts square planar coordination (i.e., Ag₂AsO₄ and Ag_{1.8}Mn₈O₁₆), which raises the possibility that it might also be used in coordination-driven A-cation ordering compositions.

Despite the apparent compatibility of Ag⁺ with the perovskite structure, there are only two known perovskites that contain Ag⁺, AgNbO₃ and AgTaO₃. The reason for this scarcity of silver-containing perovskites is not due to the crystal chemistry, but rather is the result of the low thermal stability of silver oxides. This low stability severely limits the reaction temperatures that can be used, and consequently conventional solid-state synthesis routes are not generally suitable. However, the ion-exchange and HPHT techniques of the invention can be used to synthesize new silver-containing compounds. The ion-exchange technique is applied to parent materials, such as alkali Ruddledsen-Popper family of titanates and niobates, using molten AgNO₃ to obtain perovskite-related compounds with silver layers. The HPHT technique is used to place Ag³⁺ in a LaCuO₃ lattice. Because the stoichiometric perovskite framework is not conducive to ion exchange, HPHT techniques represent the preferred method for stabilizing new perovskites containing Ag⁺.

### EXAMPLE 2

This experiment was an attempt to synthesize A-cationed ordered perovskites containing Ag⁺. The first step was to use the POTATO to generate hypothetical perovskite crystal structures. The M-O distances, which determine the size of the octahedra, were selected to optimize the bond valence of the M cation. The tilt angles were then varied to optimize the valences of the A-site cations. All bond valence and Madelung energy calculations were performed with the program EUTAX, a Macintosh based software program designed and developed for research and teaching in Crystallography, Solid State Chemistry, Materials Science, and related fields. Finally, attempts were undertaken to form synthetic perovskites for the most promising compositions identified by the modeling.

In selecting compositions to synthesize, it was determined that the search would focus on combinations of ions which would form perovskites belonging to the a⁰b⁺b⁺ tilt system. This decision was based on the fact that no representative of this tilt system are known. Thus, successful formation of an a⁰b⁺b⁺ compound would be significant. The a⁰b⁺b⁺ distortion produces a structure belonging to space group I4/mmm, with three distinct crystallographic sites for the A cations, as shown in Table 5. Like the a⁺a⁺a⁺ tilt system, some of the A-cation sites are better suited for larger A-cations (2b and 4c sites), whereas the remainder of the sites have shorter A-O bond distances and a square planar coordination (2a). However, the size difference between the “large” and “small” A-cation sites in an a⁰b⁺b⁺ is much smaller than that in an a⁺a⁺a⁺, which makes it more difficult to find suitable combinations of A-cations. As a consequence, it is necessary to find either large square planar ions or small eight-coordinate ions. (This is also true of the a⁺a⁺c⁻ and a⁰b⁻b⁺ tilt systems, which helps to explain the scarcity of perovskites in these tilt systems.)

TABLE 5
A—O BOND DISTANCES IN TILT SYSTEMS WITH POTENTIAL
FOR COORDINATION-DRIVEN A-CATION ORDERING

| TILT | BOND | UNIT CELL | WYCKOFF | | A—O BOND |
|---|---|---|---|---|---|
| SYSTEM | ANGLES (°) * | VOLUME (Å³) | POSITION | GEOMETRY | DISTANCES (Å) # |
| a⁺a⁺a⁺ | 13.3 | 409.2 | 2a | dist. cubo- | 12 × 2.63 |
| | | | | octrahedron | |
| | | | 6b | square planar | 4 × 2.00 |
| | | | | | 4 × 2.77 |
| | | | | | 4 × 3.25 |
| a⁺a⁺c⁻ | 11.3, 15.9 | 412.1 | 2b | square planar | 4 × 2.00 |
| | | | | | 4 × 3.02 |
| | | | | | 4 × 3.14 |
| | | | 2a | dist. tetrahedral | 4 × 2.08 |
| | | | | | 4 × 2.67 |
| | | | | | 4 × 3.21 |
| | | | 4d | dist. tetrahedral | 4 × 2.25 |
| | | | | | 4 × 2.67 |
| | | | | | 2 × 2.69 |
| | | | | | 2 × 3.39 |
| a⁰b⁺b⁺ | 14.5 | 423.3 | 2a | square planar | 4 × 2.00 |
| | | | | | 8 × 3.04 |
| | | | 2b | square | 8 × 2.38 |
| | | | | prismatic | 4 × 3.37 |
| | | | 4c | rectangular | 4 × 2.28 |
| | | | | planar | 4 × 2.77 |
| | | | | | 4 × 2.96 |
| a⁰b⁻b⁺ | 16.4 | 408.0 | 4c | dist. tetrahedral | 4 × 2.00 |
| | | | | | 2 × 2.76 |
| | | | | | 4 × 3.01 |
| | | | | | 2 × 3.22 |
| | | | 4c | dist. trigonal | 4 × 2.26 |
| | | | | prismatic | 2 × 2.47 |
| | | | | | 2 × 2.71 |
| | | | | | 2 × 2.84 |
| | | | | | 2 × 3.43 |

where:
* All structures were calculated with POTATO, using an M—O bond distance of 1.96 Å and the criteria that the smallest A-cation site should have from four 2.99 Å bonds for its first coordination sphere.
# A—O distances that make up the first coordination sphere are shown in bold.

All square planar ions, with the exception of the ions of silver, have ionic radii in the range 0.49-0.68 Å. (This data was reported in an article by R. D. Shannon, Acta Crystallogr. 1976, A32, 751, which is hereby incorporated by reference.) In contrast, the ionic radius of Ag⁺ in square planar coordination is 1.02 Å. This data indicates that the only suitable “large” planar ion is Ag⁺. In contrast, when searching for a small eight-coordinate ion, the choice of square planar ion is less critical, due to the rather narrow distribution of radii among the remaining square planar ions. The most obvious choice is Cu²⁺ (0.57 Å), because of its strong preference for square planar coordination. There is also considerable flexibility in the choice of the M cation, but the tests of the invention concentrated on two tetravalent cations that are commonly found in perovskites, Ti⁴⁺ and Ru⁴⁺.

Based on the hypothesis stated above, the search was directed to combinations of ions which would be expected to form stable a⁰b⁺b⁺ compounds with either Ag⁺ or Cu²⁺ on the square planar (2a) site. Table 6 summarizes the results of these calculations. Defining the structure that optimizes the bond valences of all of its constituent ions is done on a trial and error basis. In order to compare the results, the bond valences of Ag⁺ and Cu²⁺ are maintained for all compositions. When tilt angles become large, the b⁻a⁺b⁻ tilt system is generally the most stable configuration, therefore optimized structures in that tilt system were also calculated for the Ag⁺-containing system. This was not done for the Cu²⁺-containing compositions because the small size and strong preference for square planar coordination made it unlikely that Cu²⁺ would be stable on the A-site of an b⁻a⁺b⁻ perovskite.

TABLE 6
RESULTS OF POTATO MODELING CALCULATIONS

| | | TILT | LATTICE | | | | | |
|---|---|---|---|---|---|---|---|---|
| | TILT | ANGLES | ENERGY | VOLUME | BOND VALENCES | | | |
| COMPOUND | SYSTEM | (°) | (kJ/mol) | (Å ³) | A1 | A2 | A3 | M *^{e} |
| NdCa₂AgTi₄O₁₂ | a⁰b⁺b⁺ *^{a} | 0, 7 | −71,099 | 467.7 | 2.52 | 1.56 | 1.16 | 4.06 |
| | b⁻a⁺b⁻ *^{b} | −6.8, 6.8 | −70,784 | 462.0 | 2.69 | 1.80 | 1.16 | 4.06 |
| NdSr₂AgTi₄O₁₂ | a⁰b⁺b⁺ | 0, 7 | −71,099 | 467.7 | 2.52 | 2.35 | 1.16 | 4.06 |
| | b⁻a⁺b⁻ | −6.8, 6.8 | −70,784 | 462.0 | 2.69 | 2.70 | 1.16 | 4.06 |
| LaSr₂AgRu₄O₁₂ | a⁰b⁺b⁺ | 0, 7.9 | −70,482 | 478.2 | 2.86 | 2.26 | 1.16 | 4.04 |
| | b⁻a⁺b⁻ | −8.4, 8.4 | −70,396 | 465.7 | 3.37 | 2.91 | 1.16 | 4.04 |
| | b⁻a⁺b⁻ *^{c} | −6.0, 6.0 | −69,396 | 480.7 | 2.73 | 2.36 | 1.01 | 4.04 |
| MgZn₂CuTi₄O₁₂ | a⁰b⁺b⁺ | 0, 15.5 | −72,069 | 415.4 | 1.34 | 1.31 | 1.97 | 4.06 |
| CaCa₂CuTi₄O₁₂ | a⁰b⁺b⁺ | 0, 15.5 | −72,069 | 415.4 | 2.82 | 2.66 | 1.97 | 4.06 |
| Ca₂FeFeTi₄O₁₂ model structure | a⁺a⁺c⁻ *^{d} | 11.3, 16.5 | −71,195 | 409.5 | 2.83 | 2.35 | 1.83 | 4.04 |
| Ca₂FeFeTi₄O₁₂ actual structure | a⁺a⁺c⁻ | | −71,852 | 426.7 | 2.26 | 1.78 | 1.70 | 4.05 |

where:
*^{a} - For the a⁰b⁺b⁺ tilt system, the A1 cation has 8-fold coordination (Nd, La, Mg, Ca), the A2 cation 4 + 4 distorted tetrahedral coordination (Ca, Sr, Zn), and the A3 cation square planar coordination (Ag, Cu).
*^{b} - In tilt system b⁻a⁺b⁻, A1, A2 and A3 occupy the same crystallographic site and, although permitted by symmetry, this ion has not been shifted off of its ideal site.
*^{c} - With the silver bond valence at 1.16, all of the A-cations are overbonded; therefore, the tilting has been relaxed to optimize the bond valences.
*^{d} - For CaFeTi₂O₆, A1 is calcium, A2 is tetrahedral iron, and A3 is square planar iron.
*^{e} - The M cations are either Ti⁴⁺ or Ru⁴⁺: in all model calculations, the Ti—O distance is taken to be 1.96 Å and the Ru—O distance 1.98 Å.

Beginning with Ca₂NdAgTi₄O₁₂, the data in Table 6 shows that the smaller Nd³⁺ (1.109 Å) and Ca²⁺ (1.12 Å) ions are underbonded in the a⁰b⁺b⁺ tilt system. The bond valences of both cations are closer to their formal oxidation state values in the idealized b⁻a⁺b⁻ structure. Therefore, the bond valence sums suggest that Ca₂NdAgTi₄O₁₂ should form a stable b⁻a⁺b⁻ perovskite. Another important feature illustrated by the data in Table 6, is that for a constant Ag⁺ bond valence the b⁻a⁺b⁻ structure has a smaller unit cell volume than the a⁰b⁺b⁺ structure. In fact, among the tilt systems listed in Table 5, the a⁰b⁺b⁺ tilt system has the largest unit cell volume (least dense framework). A potential consequence of this is that, all other things being equal, high-pressure synthesis routes should favor those tilt systems which have the highest packing densities.

One of the obstacles to formation of an a⁰b⁺b⁺ perovskite from Ca₂NdAgTi₄O₁₂ is that the Ca²⁺ ion is too small for the AgTi₄O₁₂⁷⁻ framework. A potential solution to this problem is to replace the Ca²⁺ ion with the larger Sr²⁺ ion (1.26 Å). This results in Sr²⁺ being moderately overbonded in the a⁰b⁺b⁺ structure, but much too large for the b⁻a⁺b⁻ structure. Therefore, although the A-cation bond valences predicted for Sr₂NdAgTi₄O₁₂ are less than ideal for formation of a single-phase perovskite, substitution of Sr²⁺ for Ca²⁺ may help to stabilize the a⁰b⁺b⁺ tilt system over the b⁻a⁺b tilt system. Also, octahedral distortions can accommodate oversized and/or undersized cations. These distortions can make the bond valences more reasonable than predicted in the model structure, as illustrated by the bond valences of CaFeTi₂O₆ in Table 6.

The final Ag⁺-containing target composition tested was Sr₂LaAgRu₄O₁₂. Table 6 shows that model structures generated using this composition have very reasonable bond valences in both the a⁰b⁺b⁺ and b⁻a⁺b⁻ tilt systems. Due to the qualitative nature of the modeling, it is difficult to predict which configuration will be the most stable. However, the data indicates that Sr₂LaAgRu₄O₁₂ has a high probability of forming the first a⁰b⁺b⁺ perovskite. On the other hand, the probability of forming a stable a⁰b⁺b⁺ perovskite with Cu²⁺ on the square planar site appear to be very small. Ca²⁺ is much too large for the CuTi₄O₁₂⁶⁻ framework, and the next largest divalent ions, such as Mg²⁺ and Zn²⁺, are far too small. Therefore, synthesizing Ag⁺-containing compositions was found to have the highest probability of success.

The results of the POTATO modeling in Table 6 indicates that the b⁻a⁺b⁻ tilt system will be the most stable configuration for Ca₂NdAgTi₄O₁₂, whereas Sr₂NdAgTi₄O₁₂ (if it forms a single-phase perovskite) will be more stable in the a⁰b⁺b⁺ tilt system than the b⁻a⁺b⁻ system, and Sr₂LaAgRu₄O₁₂ appears capable of forming stable structures in either tilt system. The results also indicate that it is very unlikely that a divalent ion in combination with Cu²⁺ will form an a⁰b⁺b⁺ perovskite on the square planar site.

All HPHT synthetic attempts were carried out at 14-14.5 GPa and 1000° C. for 3 hours, followed by temperature quenching and slow decompression using the 2000-ton Uniaxial Split Sphere high-pressure apparatus (USSA 2000, manufactured by the Sumitomo Company) at Stony Brook. Our first target composition, Ca₂NdAgTi₄O₁₂, was prepared from a stoichiometric mixture of reagent grade CaTiO₃, Nd₂O₃, Ag₂O, and TiO₂. The reagents were thoroughly ground and sealed in a Au capsule with an inside diameter of 3.2 mm and a wall thickness of 0.1 mm. Following the HPHT run, conventional powder X-ray diffraction (XRD), using a diffractometer (manufactured by Scintag, Inc. of Cupertino, Calif.) with θ-θ geometry and CuKα radiation, showed the sample to be almost exclusively a perovskite. However, a small amount of Srilankite, a high-pressure polymorph of TiO₂, was also present. Electron probe microanalysis showed that the sample was homogeneous and possessed a metal ratio consistent with the desired product, NdCa₂AgTi₄O₁₂.

The same experimental procedures were then repeated with SrTiO₃ in place of CaTiO₃, with the intention of finding the analogous compound, Sr₂NdAgTi₄O₁₂. The results of the XRD and electron microprobe analysis showed the sample to be a mixture of at least three phases. One phase was clearly SrTiO₃ and the other phases belonged to the solid solution Sr_{1-2X}NdₓAgₓTiO₃. This result suggested the existence of NdAgTi₂O₆ and, therefore, the aforementioned experimental procedures were repeated, starting from Nd₂O₃, Ag₂O and TiO₂. Conventional powder XRD patterns indicated the product of this run to be a single-phase perovskite, with metal ratios (determined using electron probe microanalysis) of 0.97(2)Nd:1.00(2)Ag:1.97(1)Ti. Once again a small amount of Srilankite was present as an impurity phase. Synthesis of Sr₂LaAgRu₄O₁₂ from SrRuO₃, RuO₂, Ag₂O, and La₂O₃ was not successful. The XRD analysis showed that the HPHT treatment reduced Ag₂O to silver metal, but the remaining starting materials did not appear to react.

Synchrotron powder XRD data were collected at the X7A beamline at the National Synchrotron Light Source, Brookhaven National Laboratory. Samples were first loaded into 0.2-mm diameter glass capillaries, which were freely rotated at 1-2 Hz during data collection to avoid potential problems with preferred orientation or texture. Monochromatic radiation was obtained using a channel-cut Ge (111) monochromator. The data were collected by step scanning over the approximate angular range 10°<2θ<60° in increments of 0.25° using a position sensitive detector (PSD). Rietveld refinements were carried out using the GSAS software suite.

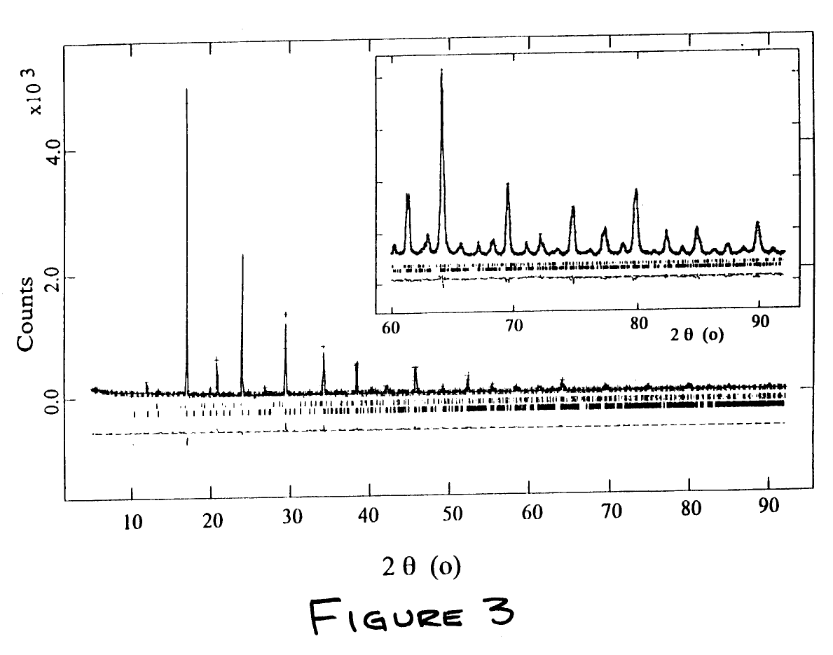

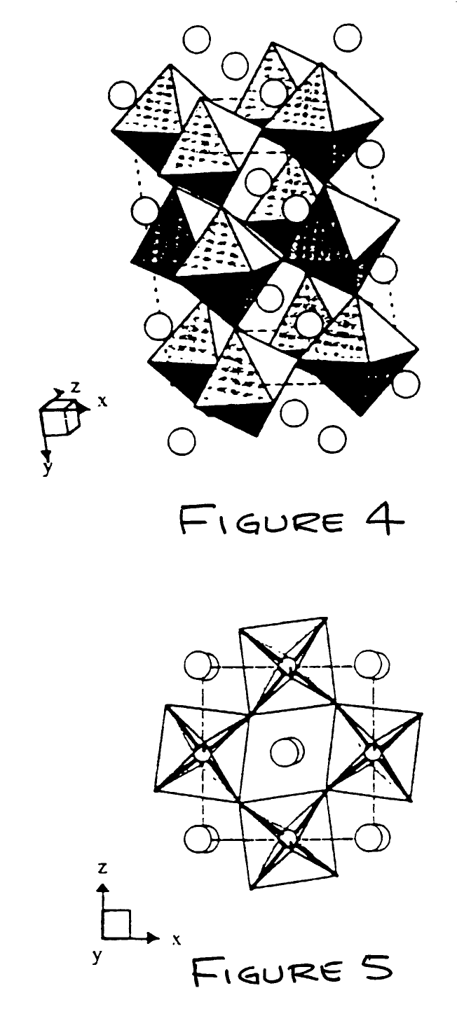

Rietveld refinements confirm that Ca₂NdAgTi₄O₁₂ is a perovskite. The structure has Pnma symmetry, as expected for a member of the b⁻a⁺b⁻ tilt system, with a=5.44883(4), b=7.68915(6), and c=5.42290(3) Å. The refinement parameters are summarized in Tables 7 and 8, select bond distances and angles are given in Table 9, and cation bond valences are listed in Table 10. The observed, calculated and difference patterns from the Rietveld refinement of the structure of Ca₂NdAgTi₄O₁₂ at room temperature are shown in FIG. 3. The upper and lower ticks indicate the positions of reflections from the high-pressure TiO₂ phase and Ca₂NdAgTi₄O₁₂, respectively. The difference curve is shown in the bottom on the same scale. The high-angle area (60°<2θ<92°) is magnified. A representation of the Ca₂NdAgTi₄O₁₂ structure is illustrated in FIGS. 4 and 5. FIG. 4 shows the TiO₆ octahedral linkages of Ca₂NdAgTi₄O₁₂, wherein the unit cell is indicated by a dashed line and open circles represent disordered Ca/Ag/Nd sites. FIG. 5 shows the projection of the Ca₂NdAgTi₄O₁₂ structure on the xz plane, wherein Ti atoms are represented as smaller circles in the center of octahedra.

Even though the Ca²⁺, Nd³⁺, and Ag⁺ ions are randomly distributed on the A-site for the Ca₂NdAgTi₄O₁₂ structure, the thermal parameters of all ions are reasonable and the observed bond valences are very close to those predicted by POTATO. Based on the fractional coordinates of the oxygen ions, the octahedral tilt angles are estimated to be 7.4(1)° (clockwise) for the out of phase tilts about the x and z axes (b⁻) and −7.7(2)° (counterclockwise) for the in phase tilt about they axis (a⁺). These values are slightly larger than predicted in the modeling section, presumably because once the A cation shifts off of the 0,1/4,0 position, it relieves the electron-electron repulsion associated with short A-O bonds and allows the TiO₃ framework to collapse further.

TABLE 7
CRYSTALLOGRAPHIC DATA FOR
NdAgTi₂O₆ and Ca₂NdAgTiO₁₂

| PARAMETER | N_{d}AgTi₂O₆ | Ca₂NdAgTiO₁₂ |
|---|---|---|
| wavelength (Å) | 0.650653 | 0.79990 |
| 2θ range (°) | 3-60 | 9-90 |
| space group | P4/nbm | Pnma |
| cell parameters (Å) | a = 5.45337(3) | a = 5.44883(4) |
| | c = 7.72934(6) | b = 7.68915(6) |
| | | c = 5.42290(3) |
| number of variables | 17 | 16 |
| number of data | 512 | 728 |
| R_{wp} | 0.0673 | 0.0620 |
| Rₚ | 0.0439 | 0.0412 |
| R(F²) | 0.0483 | 0.0816 |
| Reduced χ² | 17.49 | 12.67 |

TABLE 8
ATOMIC POSITIONAL PARAMETERS, EQUIVALENT ISOTROPIC
DISPLACEMENT COEFFICIENTS (Å² × 10³). AND
ANISOTROPIC DISPLACEMENT PARAMETERS OF METAL IONS

| | | | | Occu- | |
|---|---|---|---|---|---|
| NdAgTi₂O₆ | x | y | z | pancy | U₁₈₀ |
| Nd(1) | 0.75000 | 0.25000 | 0.00000 | 0.75(2) | 0.0120(1) |
| Nd(2) | 0.75000 | 0.25000 | 0.50000 | 0.25(2) | 0.0120(1) |
| Ag(1) | 0.75000 | 0.25000 | 0.50000 | 0.75(2) | 0.0120(1) |
| Ag(2) | 0.75000 | 0.25000 | 0.00000 | 0.25(2) | 0.0120(1) |
| Ti | 0.25000 | 0.25000 | 0.2492(8) | 1.00000 | 0.0058(5) |
| O(1) | 0.25000 | 0.25000 | 0.00000 | 1.00000 | 0.059(3) |
| O(2) | 0.25000 | 0.25000 | 0.50000 | 1.00000 | 0.059(3) |
| O(3) | 0.4651(5) | 0.9651(5) | 0.233(1) | 1.00000 | 0.008(1) |

| | U₁₁ | U₂₂ | U₃₃ | U₁₂ | U₁₃ | U₂₃ |
|---|---|---|---|---|---|---|
| Ag/Nd | 0.0128(1) | 0.0128(1) | 0.0104(3) | 0.0 | 0.0 | 0.0 |
| Ti | 0.0087(4) | 0.0087(4) | −0.00023(7) | 0.0 | 0.0 | 0.0 |

| Ca₂NdAgTi₄O₁₂ | x | y | z | Occupancy | U₁₈₀ |
|---|---|---|---|---|---|
| Ca | 0.0190(1) | 0.25000 | 0.0044(3) | 0.503(1) | 0.00564(9) |
| Nd | 0.0190(1) | 0.25000 | 0.0044(3) | 0.253(1) | 0.00564(9) |
| Ag | 0.0190(1) | 0.25000 | 0.0044(3) | 0.253(1) | 0.00564(9) |
| Ti | 0.50000 | 0.00000 | 0.00000 | 1.00000 | 0.0033(2) |
| O(1) | 0.7180(7) | −0.0323(6) | 0.2854(7) | 1.00000 | 0.0042(9) |
| O(2) | −0.0146(9) | 0.25000 | 0.434(1) | 1.00000 | 0.009(2) |

TABLE 9
SELECT INTERATOMIC DISTANCES (Å) AND ANGLES (°)

| | | |
|---|---|---|
| DISTANCE (Å) | ANGLE | DEGREE |

NdAgTi₂O₆

| | | | |
|---|---|---|---|
| Ti—O(4) | 1.930(7) | O(4)—Ti—O(5) | 180.0 |
| Ti—O(5) | 1.934(7) | O(4)—Ti—O(6) × 4 | 86.3(3) |
| Ti—O(6) × 4 | 1.9510(8) | O(5)—Ti—O(6) × 4 | 93.7(3) |
| Nd(1)—O(4) × 4 ^{a} | 2.727(2) | O(6)—Ti—O(6) × 4 | 89.75(4) |
| Nd(1)—O(6) × 4 ^{a} | 2.842(7) | O(6)—Ti—O(6) × 2 | 172.0(5) |
| Nd(1)—O(6) × 4 ^{a} | 2.450(7) | Ti—O(4)—Ti | 180.0 |
| Ag(1)—O(5) × 4 ^{b} | 2.727(2) | Ti—O(5)—Ti | 180.0 |
| Ag(1)—O(6) × 4 ^{b} | 2.646(8) | Ti—O(6)—Ti | 162.0(3) |
| Ag(1)—O(6) × 4 ^{b} | 3.013(7) | — | — |

Ca₂NdAgTi₄O₁₂

| | | | |
|---|---|---|---|
| Ti—O(5) × 2 | 1.944(4) | O(5)—Ti—O(5) × 2 | 180.0 |
| Ti—O(5) × 2 | 1.967(4) | O(5)—Ti—O(5) × 2 | 89.43(4) |
| Ti—O(6) × 2 | 1.957(1) | O(5)—Ti—O(5) × 2 | 90.57(4) |
| Ca(1)—O(5) × 2 ^{c} | 3.142(3) | O(5)—Ti—O(6) × 2 | 89.1(2) |
| Ca(1)—O(5) × 2 ^{c} | 2.402(3) | O(5)—Ti—O(6) × 2 | 90.9(2) |
| Ca(1)—O(5) × 2 ^{c} | 2.679(5) | O(5)—Ti—O(6) × 2 | 89.7(2) |
| Ca(1)—O(5) × 2 ^{c} | 2.702(5) | O(5)—Ti—O(6) × 2 | 90.3(2) |
| Ca(1)—O(6) ^{c} | 3.051(6) | O(6)—Ti—O(6) | 180.0 |
| Ca(1)—O(6) ^{c} | 2.384(6) | Ti—O(5)—Ti | 158.8(2) |
| Ca(1)—O(6) ^{c} | 2.932(5) | Ti—O(6)—Ti | 158.4(3) |
| Ca(1)—O(6) ^{c} | 2.570(5) | — | — |

where: a - Nd(1) represents the Nd-dominated site.
b - Ag(1) represents the Ag-dominated site.
c - Ca(1) represents the Cd/Nd/Ag disordered site.

TABLE 10
CATION BOND VALENCES

| CATION | NdAgTi₂O₆ | Ca₂NdAgTi₄O₁₂ |
|---|---|---|
| Ag | 0.90 | 1.16 |
| Nd | 2.96 | 2.69 |
| Ca | — | 1.91 |
| Ti | 4.23 | 4.06 |

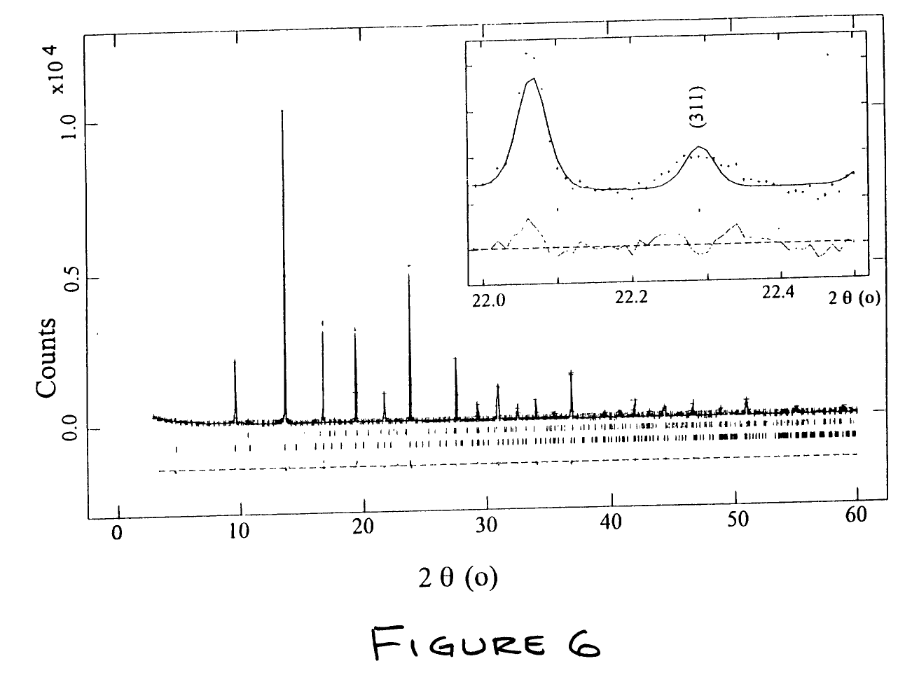

All peaks in the NdAgTi₂O₆ diffraction pattern shown in FIG. 6 were indexed to either a tetragonal perovskite, with a √2αₚ×√2αₚ×√2αₚ unit cell (αₚ=the simple cubic perovskite cell dimension) or Srilankite. The extinction conditions for NdAgTi₂O₆ are consistent with the tetragonal space group P4/nbm (No. 125). The presence of the (001) reflection at 4.84° 2θ indicates that layered cation ordering, perpendicular to the c axis, has occurred. This type of ordering by itself results in a doubling of the c axis and a reduction in symmetry from Pm3m to P4 mmm. The enlarged unit cell and P4nbm symmetry suggest that more than one type of symmetry-lowering distortion mechanism is at work in NdAgTi₂O₆. In analyzing the data, it was first noted that P4nbm is an isomorphic subgroup of I4mcm, which is the expected space group for a compound that has undergone a⁰a⁰c⁻ octahedral tilting. A subsequent symmetry analysis showed that the combination of layered A-cation ordering and an a⁰a⁰c⁻ octahedral tilting distortion results in a structure with P4nbm symmetry. Rietveld refinements confirm the presence of both distortion mechanisms. The octahedral tilting angle about the c axis is estimated to be 7.95(1)°.

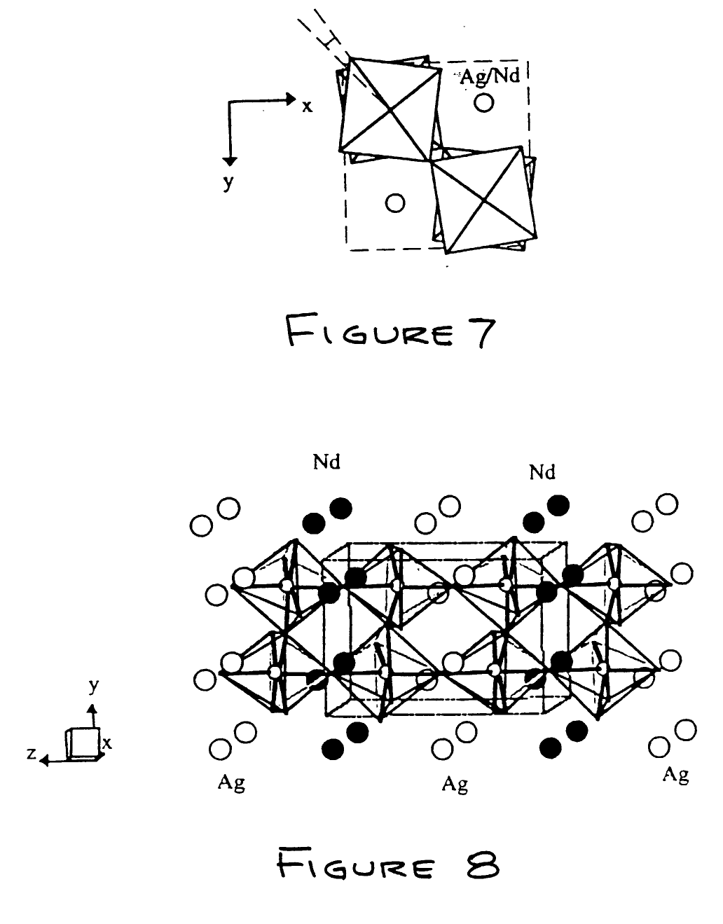

The degree of Nd³⁺/Ag⁺ ordering was estimated by refining the fractional parameter for each A-site so that both A-sites remain fully occupied and an Ag:Nd ratio of unity was maintained. The refinement showed that 75% of the Nd³⁺ is accommodated on the 2c site, whereas a corresponding amount of Ag⁺ resided on the 2d site. Bond valence calculations supported this conclusion. The temperature factors of these sites were varied but constrained to be equal, to avoid correlation between the thermal parameters and fractional occupancies. The refinement parameters are summarized in Tables 7 and 8. FIG. 6 shows the results of the Rietveld refinement of the structure of NdAgTi₂O₆ at room temperature with the observed, calculated, and difference patterns. The upper and lower ticks indicate the positions of reflections from the high-pressure TiO₂ phase and NdAgTi₂O₆, respectively. The difference curve is shown in the bottom on the same scale. The angle region between 22° and 22.5° is magnified in the box above to show the superlattice peak such as (311). The peak broadness indicates partial ordering of Nd³⁺ and Ag¹⁺ between the two available A cation sites. A representation of the NdAgTi₂O₆ structure is shown in FIGS. 7 and 8. FIG. 7 shows a projection of the structure of NdAgTi2O₆ on the xy plane showing the 7.95(1)° octahedral tilting angle along the c axis. FIG. 8 shows the TiO₆ octahedral linkages of NdAgTi₂O₆ with O3 in the TiO layer shifted toward Nd³⁺. The unit cell is indicated by a dashed line and shaded and closed circles represent Ag and Nd dominated sites, respectively.

The supercell peaks in FIG. 6, which arise due to cation ordering (those violating the body centered reflection conditions), were observed to be broader than the subcell peaks, indicating the presence of antiphase domains in the Ag—Nd—Ag—Nd stacking sequence. To estimate the concentration of antiphase boundaries, a Williamson-Hall type analysis, with no correction for instrumental broadening, was performed on select peaks. The analysis indicated that the crystallite size (calculated from the subcell peaks) was 770 Å, whereas the ordered domain size (calculated from supercell peaks) was 380 Å. Although this analysis does not provide quantitatively accurate values, the analysis clearly indicates the presence of antiphase boundaries in NdAgTi₂O₆.

The formation of Ca₂AgNdTi₄O₁₂ as a single-phase perovskite, shows the potential of the POTATO/HPHT approach. The striking agreement between the predicted and observed bond valences for this compound demonstrates the ability of POTATO to accurately predict hypothetical perovskite structures. The formation of this compound together with AgNdTi₂O₆ clearly shows that the HPHT techniques of the invention are capable of incorporating the Ag⁺ cation into the perovskite structure. This incorporation is not possible for most compounds using conventional solid-state synthesis techniques.

The formation of multiple perovskite phases in the case of Sr₂AgNdTi₄O₁₂ was anticipated by the predictive modeling, which showed that the b⁻a⁺b⁻ tilt system was incapable of simultaneously satisfying the valence requirements of Sr²⁺, Ag⁺, and Nd³⁺. For the Sr₂AgNdTi₄O₁₂ composition, the bond valences of the a⁰b⁺b⁺ structure were more reasonable. However, it would have been illogical to expect the largest A-site cation, Ag⁺, to occupy a square planar site in preference to the 8-coordinate A-site found in b⁻a⁺b⁻ perovskites. In addition, the probability of Ag⁺ occupying the square planar site was further diminished by the high-pressure synthesis, which favors the more efficient ion packing of the b⁻a⁺b⁻ tilt system.

The failure of Sr₂AgLaRu₄O₁₂ to form a single-phase perovskite was completely unexpected from the modeling calculations. This shows that even though a perovskite with this composition would be stable, the formation of such a compound from the starting materials is an endothermic process. This problem can be overcome by incorporating thermodynamic calculations into the modeling process. The calculations include using the equations of state (EOS) for the starting components to evaluate ΔV for the breakdown reaction. These calculations also include the bond valence parameters valid at high temperatures and pressures.

An examination of the of AgNdTi₂O₆ compound is useful in understanding the present invention. The AgNdTi₂O₆ structure can be visualized as stacking NdO⁺, AgO⁻, and TiO₂ layers in a Nd—Ti—Ag—Ti— . . . sequence. The oxygen ions in the TiO₂ layers (O3) are shifted by 0.12 Å toward the NdO⁺ layer, whereas the titanium ions are essentially equidistant from the NdO⁺ and AgO⁻ layers. This distortion is driven by the electrostatic attraction of oxygen to the positively charged NdO⁺ layer. It is interesting to compare this distortion with the one observed in La_{0.55}-Li_{0.33}□_{0.12}TiO₃, where lanthanum is both larger and more highly charged than lithium. In the La_{0.55}-Li_{0.33}□_{0.12}TiO₃ compound, the oxygen ions also have an electrostatic attraction to the positively charged lanthanum-rich layers, but ion-ion repulsion and/or the valency requirements of the smaller Li⁺ cation cause the O3 ion to shift 0.03 Å toward the negatively charged lithium-rich layer. However, electrostatic interactions do result in a 0.14 Å shift of the Ti⁴⁺ ions toward the lithium-rich layer. This results in a very long (2.05-2.08 Å) distance between titanium and the oxygen in the lanthanum-rich layer, giving rise to one long and five short Ti—O bonds. Consequently, the octahedral distortions in La_{0.55}-Li_{0.33}□_{0.12}TiO₃ and AgNdTi₂O₆ are very different, but these distortions appear to be mainly driven by the size and charge of the A cations rather than Ti—O covalent bonding interactions.

AgNdTi₂O₆ represents the first example of A-cation ordering, driven by charge and/or size differences, in a compound with a single octahedral cation and a 1:1 A:A′ ratio. To determine why A-cation ordering is found so infrequently and to determine the attributes of AgNdTi₂O₆ which are responsible for stabilizing the layered A-cation ordering, a series of Madelung energy calculations were carried out on idealized structures. The results are listed in Table 11. First, the Madelung energy of a cubic A²⁺M⁴⁺O₃ structure, with A-O and M-O distances of 2.76 and 1.90 Å, respectively, was calculated. Then, without altering bond distances, the cation distribution was changed to simulate rock salt ordering of M³⁺/M⁵⁺ and layered ordering of A⁺/A³⁺. Although both types of ordering are energetically favored, the stabilization energy associated with M³⁺/M⁵⁺ ordering is more than twice as large as the stabilization accompanying A⁺/A³⁺ ordering. This result partially explains why M-cation ordering is so much more prevalent than A-cation ordering. Each ordered structure can be further stabilized with respect to the disordered structure by shifting the oxygen ions closer to the higher valent cation (either M⁵⁺ or A³⁺). Thus, the size difference between Ag⁺(1.28 Å) and Nd³⁺ (1.11 Å), which results in a shift of the oxygen ions toward the higher valent neodymium cation, plays an important role in stabilizing the ordered structure. By comparison, the size difference between Na⁺ (1.18 Å) and La³⁺ (1.16 Å) is much smaller and, consequently, ordering is not observed in NaLaTi₂O₆.

TABLE 11
MADELUNG ENERGY CALCULATIONS OF VARIOUS ORDERED PEROVSKITES

| | | | | | MADELUNG | ORDERING |
|---|---|---|---|---|---|---|
| | M³⁺—O | M⁵⁺—O | A⁺—O | A⁺—O | ENERGY per | ENERGY |
| COMPOUND | (Å) | (Å) | (Å) | (Å) | Ti (kJ/mol) | (% change) |
| A²⁺M⁴⁺O₃ *a | — | — | — | — | −17,638 | 0 |
| A₂M³⁺M⁵⁺O₆ *b | 6 × 1.90 | 6 × 1.90 | — | — | −17,949 | 1.8 |
| A₂M³⁺M⁵⁺O₆ *b | 6 × 2.03 | 6 × 1.87 | — | — | −18,236 | 3.4 |
| A₂M³⁺M⁵⁺O₆ *b | 6 × 1.87 | 6 × 2.03 | — | — | −17,689 | 0.3 |
| A⁺A³⁺M₂O₆ *c | — | — | 12 × 2.76 | 12 × 2.76 | −17,776 | 0.8 |
| A⁺A³⁺M₂O₆ *c | — | — | 4 × 2.76 | 4 × 2.76 | −17,469 | −1.0 |
| | | | 8 × 2.68 | 8 × 2.84 | | |
| A⁺A³⁺M₂O₆ *c | — | — | 4 × 2.76 | 4 × 2.76 | −17,936 | 1.7 |
| | | | 8 × 2.84 | 8 × 2.68 | | |

where: *a - the ideal perovskite structure, a = 3.90 Å, space group Pm3m.
*b - ordered cubic perovskite structure, a = 7.8 Å, space group Fm3m.
*c - layered A-cation ordered structure, a = 3.9 Å, space group P4/mmm.

All of the compositions and methods disclosed and claimed herein can be made and executed without undue experimentation in light of the present disclosure. While the compositions and methods of this invention have been described in terms of preferred embodiments, it will be apparent to those of skill in the art that variations may be applied to the composition, methods and in the steps or in the sequence of steps of the method described herein without departing from the concept, spirit and scope of the invention. More specifically, it will be apparent that certain agents which are chemically related may be substituted for the agents described herein while the same or similar results would be achieved. All such similar substitutes are deemed to be within the spirit, scope and concept of the invention as defined by the appended claims.

We claim:

1. A method for providing a perovskite having a dielectric constant of at least 20 and a structure which is stable at pressures above 1 GPa, said method comprising:
identifying a composition having at least a 50 percent probability of forming a stable structure, wherein said identification comprises estimating the dielectric constant of said composition and predictive modeling the structure of said stable structure with the computer program called “Program Originated To Analyze Tilted Octrahedral” to determine the stability of said stable structure; and
subjecting said composition to a pressure of at least about 5.0 GPa and a temperature of at least about 700° C. to form said stable structure;
wherein said stable structure has a dielectric constant of at least 20 and is stable in the high pressure phase above 1 GPa.

2. The method according to claim 1, wherein said stable structure comprises a three-dimensional framework of corner-linked MX₆ octahedra.

3. The method according to claim 2, wherein said predictive modeling uses the metal-oxygen bond distance of said stable structure to select the bond valence of the metal cation so that bond valence of the metal cation in relation to the bond valences of said stable structure's constituent ions will provide a stable structure.

4. The method according to claim 1, wherein identifying said composition further comprises estimating the molecular polarizability of said composition by summing the atomic polarizabilities of said composition's constituent ions, determining said composition's molar volume based on the atomic radii of said composition's constituent ions and calculating said composition's relative dielectric constant using the Clausius-Mossotti equation.

5. The method according to claim 1, further comprising reducing the pressure to about one atmosphere pressure, wherein said synthesized structure remains stable.

6. The method according to claim 1, wherein said stable structure is an A-cationed ordered perovskite.

7. The method according to claim 2, wherein said synthesizing comprises distorting said structure.

8. The method according to claim 1, wherein said composition comprises oxygen ions and cations.

9. The method according to claim 8, wherein said synthesizing comprises shifting said oxygen ions closer to said cations.

10. The method according to claim 1, wherein said synthesis of said composition comprises a phase transition.

11. The method according to claim 1, wherein the probability of forming a stable structure from said composition is at least two out of three.

12. The method according to claim 1, wherein said synthesis of said composition comprises a structural transition to a denser phase.

13. The method according to claim 1, wherein said synthesis is carried out at temperatures of at least 1000° C. and pressures of at least 5GPa.

14. The method according to claim 1, wherein said composition is a metal oxide compound.

15. The method according to claim 1, wherein said identifying further comprises selecting combinations of ions having complimentary ionic radii and bonding preferences.

16. The method according to claim 2, wherein said estimating comprises calculating the dielectric characteristics of said stable structure based on the size of the octahedra, the octahedra tilt system and the magnitude of the tilt angles.

17. A method for providing a perovskite structure having a dielectric constant of at least 20 and a structure which is stable at pressures above 1 GPa, said method comprising:
identifying an ilmenite composition having at least a 50 percent probability of forming a stable perovskite structure, wherein said identification comprises estimating the dielectric constant of said composition and predictive modeling the structure of said stable perovskite structure with the computer program called “Program Originated To Analyze Tilted Octrahedral” to determine the stability of said stable perovskite structure; and
subjecting said ilmenite composition to a pressure of at least about 5.0 GPa and a temperature of at least about 700° C. to form said stable perovskite structure; wherein said stable perovskite structure has a dielectric constant of at least 20 and is stable in the high pressure phase above 1 GPa.

18. The method according to claim 17, wherein said stable perovskite structure comprises a three-dimensional framework of corner-linked MX₆ octahedra.

19. The method according to claim 18, wherein said predictive modeling uses the metal-oxygen bond distance of said stable structure to select the bond valence of the metal cation so that bond valence of the metal cation in relation to the bond valences of said table structure's constituent ions will provide a stable structure.

20. The method according to claim 17, wherein said predictive modeling further comprises estimating the molecular polarizability of said composition by summing the atomic polarizabilities of said composition's constituent ions, determining said composition's molar volume based on the atomic radii of said composition's constituent ions and calculating said composition's relative dielectric constant using the Clausius-Mossotti equation.

21. The method according to claim 17, further comprising reducing the pressure to about one atmosphere pressure, wherein said synthesized perovskite structure remains stable.

22. The method according to claim 17, wherein said stable perovskite structure is an A-cationed ordered perovskite.

23. The method according to claim 17, wherein said synthesizing comprises distorting said structure.

24. The method according to claim 17, wherein said composition comprises oxygen ions and cations.

25. The method according to claim 24, wherein said synthesizing comprises shifting said oxygen ions closer to said cations.

26. The method according to claim 17, wherein said synthesis of said composition comprises a phase transition.

27. The method according to claim 17, wherein the probability of forming a stable perovskite structure from said composition is at least two out of three.

28. The method according to claim 17, wherein said synthesis of said composition comprises a structural transition to a denser phase.

29. The method according to claim 17, wherein said synthesis is carried out at temperatures of at least 1000° C. and pressures of at least 5GPa.

30. The method according to claim 17, wherein said composition is a metal oxide compound.

31. The method according to claim 17 wherein said identifying further comprises selecting combinations of ions having complimentary ionic radii and bonding preferences.

32. The method according to claim 17, wherein said estimating comprises calculating the dielectric characteristics of said stable perovskite structure based on the size of the octahedra, the octahedra tilt system and the magnitude of the tilt angles.

33. A method for providing a perovskite structure having a dielectric constant of at least 20 and a structure which is stable at pressures above 1 GPa, said method comprising:
identifying a composition having at least a 50 percent probability of forming a stable perovskite structure comprising a three-dimensional framework of corner-linked MX₆ octahedra, wherein said identification comprises estimating the dielectric constant of said composition and predictive modeling the structure of said stable structure with the computer program called “Program Originated To Analyze Tilted Octrahedral” to determine the stability of said stable structure, wherein said predictive modeling comprises:
using the metal-oxygen bond distance of said stable structure to select the bond valence of the metal cation so that bond valence of the metal cation in relation to the bond valences of said stable structure's constituent ions will provide a stable structure;
estimating the molecular polarizability of said composition by summing the atomic polarizabilities of said composition's constituent ions, determining said composition's molar volume based on the atomic radii of said composition's constituent ions and calculating said composition's relative dielectric constant using the Clausius-Mossotti equation; and
selecting combinations of ions having complimentary ionic radii and bonding preferences; and
subjecting said composition to a pressure of at least about 5.0 GPa and a temperature of at least about 700° C. to form said stable perovskite structure, wherein said synthesis comprises:
distorting said structure; and
inducing a structural transition of said composition to a denser phase,
wherein said stable perovskite structure has a dielectric constant of at least 20 and is stable in the high pressure phase above 1 GPa.

34. The method according to claim 33, wherein said composition is an ilmenite composition.

35. The method according to claim 33, wherein said stable perovskite structure is an A-cationed ordered perovskite.
